(19) United States
(12) Patent Application Publication
(10) Pub. No.: US 2022/0223976 A1
(43) Pub. Date: Jul. 14, 2022

(54) IMPROVED COATED BATTERY SEPARATORS AND BATTERIES

(71) Applicant: Celgard, LLC, Charlotte, NC (US)

(72) Inventors: Insik Jeon, Ithaca, NY (US); James Rapley, Concord, NC (US); Xiang Yu, Indian Land, SC (US); Fru Azeh, Charlotte, NC (US); Salvatore Cardillo, Munster (FR)

(21) Appl. No.: 17/613,106

(22) PCT Filed: May 21, 2020
(86) PCT No.: PCT/US2020/034046

§ 371 Date: Nov. 22, 2021

Related U.S. Application Data
(60) Provisional application No. 62/852,350, filed on May 24, 2019.
(60) Provisional application No. 62/956,905, filed on Jan. 3, 2020.

(51) Int. Cl. H01M 50/449; H01M 50/426; H01M 50/417; H01M 50/572; H01M 50/42

(52) U.S. Cl. CPC H01M 50/449; H01M 50/426; H01M 50/42; H01M 50/572; H01M 50/417

(57) ABSTRACT

A coated separator or coated porous membrane comprising a coating on one or two sides of a separator membrane or porous membrane is disclosed. The coating may contain at least one of an adhesion agent, a shutdown agent, and a binder. The coating containing these components does not contain any inorganic or organic heat resistant materials, including ceramic materials, or it contains inorganic or organic heat resistant materials, including ceramic materials, in small amounts. The separator may be a separator that does not, by itself, have shutdown capability. For example, the separator membrane of the separator may be a monolayer separator membrane made of polypropylene. Also disclosed is a battery cell, a secondary battery, and a capacitor containing at least one of the coated separators disclosed herein.

### CROSS-REFERENCE TO RELATED APPLICATIONS

The present application is a 371 U.S. Application of PCT/US2020/034046, filed May 21, 2020, which claims priority to and the benefit of U.S. provisional patent application Ser. Nos. 62/852,350, filed May 24, 2019, and 62/956,905, filed Jan. 3, 2020, both hereby fully incorporated by reference herein.

### FIELD

This application is directed to improved battery separators having, among other things, improved safety, improved ease of handling, and improved ease of use in battery manufacture.

### BACKGROUND

Increasing performance standards, safety standards, manufacturing demands, and/or environmental concerns make development of new and/or improved coating compositions for battery separators desirable.

One major safety issue for lithium-ion batteries is thermal runaway. Abuse conditions, such as overcharge, over-discharge, and internal short-circuits, for example, can lead to battery temperatures far above those which the temperatures that battery manufacturers intended their batteries to be used. Tests for simulating abuse conditions may include, but are not limited to nail penetration tests and hot-box tests. Shutdown of the battery, e.g., a stopping of ionic flow across the separator, e.g., between an anode and a cathode in the event of thermal runaway, is a safety mechanism used to prevent thermal runaway. Separators in at least certain lithium-ion batteries must offer the ability to shutdown at temperatures at least slightly lower than that at which thermal runaway occurs, while still retaining their mechanical properties. Faster shutdown at lower temperatures and for a longer duration, e.g., so that the user or device has longer time to turn off the system, is very desirable.

Celgard U.S. Pat. No. 5,952,120, which is incorporated by reference herein in its entirety, discloses a shutdown trilayer separator. This separator exhibits shutdown at least because of its inner polyethylene layer. The polyethylene melts and closes the pores of the separator at temperatures near the melting point of polyethylene. However, some separators do not have the ability to shutdown at low temperatures (e.g., at about 135° C. or below) on their own. For example, monolayer separators made of polypropylene may not. Thus, it is also desirable to be able to provide low-temperature shutdown capability to a separator that may not have such capability by itself.

As the market demands thinner and thinner separators, the ability to handle these very thin separators becomes more and more important. Thus, the creation of an easier to handle separator is very desirable.

As the demand for thinner separators increases, the ease in which battery separators can be used to manufacture battery cells is important too. Thus, the creation of a separator that can easily be used to manufacture a wide range of different battery cell types is very desirable.

### SUMMARY

In one aspect, a coated separator or a coated porous membrane is described herein. The coated separator or coated porous membrane comprises, a separator or porous membrane and at least one coating that comprises, consists of, or consists essentially of at least one selected from the group of an adhesion agent, a shutdown agent, and a binder. The coating, in some embodiments, does not contain any of either of inorganic or organic heat resistant particles, but in other embodiments, the coating may comprise a small amount of inorganic and/or organic heat resistant particles (less than 10% or less than 5% of total solids). In some embodiments, the coated separator or coated porous membrane may have another coating that does comprise, consist of, or consist essentially of more than small amounts of ceramic or inorganic or organic heat resistant particles. This coating may be provided directly on top of the layer that does not contain more than small amounts of ceramic or organic or inorganic heat resistant particles. However, the layer that comprises, consists of, or consists essentially of at least one of an adhesion agent, a shutdown agent, and a binder does not contain more than small amounts of ceramic or organic or inorganic heat resistant particles.

In some embodiments, the coating may comprise, consist of, or consist essentially of an adhesion agent. In some embodiments, the coating may comprise an adhesion agent and a binder. The adhesion agent may comprise, consist of, or consist essentially of at least one selected from the group of a wet adhesion agent and a dry adhesion agent. The wet adhesion agent may comprise, consist of, or consist essentially of PVDF, an acrylic polymer or combinations thereof. The dry adhesion agent may comprise, consist of, or consist essentially of a dry adhesion polymer that comprises, consists of, or consists essentially of a PVDF-HFP copolymer or an acrylic having a glass transition temperature less than 100° C., preferably between 30° C. and 80° C. The adhesion agent may comprise, consist of, or consist essentially of a dry adhesion agent alone, a wet adhesion agent alone, or a dry adhesion agent and a wet adhesion agent.

In some embodiments, the coating may comprise, consist of, or consist essentially of a shutdown agent. In some embodiments, the coating may comprise a shutdown agent and a binder. The shutdown agent may comprise, consist of, or consist essentially of beads or particles made of a polymer having a melting point from about 100° C. to about 140° C. In some embodiment, PE beads having a melting point from 100° C. to 140° C. may be used. In some embodiments, the shutdown agent may comprise, consist of, or consist essentially at least one selected from the group of beads or particles made of a polymer having a melting point from about 130° C. to about 140° C.; beads or particles made of a polymer having a melting point from about 80° C. to about 130° C.; beads or particles having a melting point of 140° C. to 220° C., and combinations thereof.

In some embodiments, the coating may comprise, consist of, or consist essentially of an adhesion agent and a shutdown agent. In some embodiments, the coating may comprise, consist of, or consist essentially of an adhesion agent, a shutdown agent, and a binder. The adhesion agent may include a dry adhesion agent alone, a wet adhesion agent alone, or both a wet and dry adhesion agent.

The coated separator or coated porous membrane may be a one-side coated separator or a one-side coated porous membrane or a two-side coated separator or a two-side coated porous membrane. For a two-side coated separator or a two-side coated porous membrane one or both sides may comprise a coating as described herein or one side may comprise a coating as described herein and the other may comprise a different coating. A different coating may be, for example, a ceramic coating, a polymer coating, and the like. An exemplary one-side and two-side coated separator or porous membrane is shown in FIG. 1.

In some embodiments, the separator of the coated separator may be one that does not have shutdown capability at temperatures below 150° C. or 140° C. without the coating. In some embodiments, the separator that does not have shutdown capability is a dry process separator. In some embodiments, the separator is a separator consisting of or consisting essentially of polypropylene. In some embodiments, the separator is a monolayer polypropylene separator.

In some embodiments, the porous membrane of the coated porous membrane may be a microporous, macroporous, or mesoporous porous membrane. The porous membrane may be a porous membrane formed by a dry process.

In another aspect, a battery cell comprising at least one coated separator as described herein is described. The cell may be at least one selected from a cylindrical cell, a pouch cell, a prismatic cell, a wound cell, a folded cell, a wrapped cell, a pocket cell or a stacked cell.

In another aspect, a secondary battery comprising at least one coated separator as described herein is described.

In another aspect, a capacitor comprising at least one of the coated separators described herein is described.

In one aspect, a coated battery separator is described herein. The coated separator has at least one coating that does not contain any ceramic or heat resistant particles, and comprises, consists of, or consists essentially of an adhesion agent and a shutdown agent. In some embodiments, the coating may consist of an adhesion agent and a shutdown agent. In some embodiments, the coating may consist essentially an adhesion agent, a shutdown agent, and an optional binder. In some embodiments, the coating may comprise an adhesion agent, a shutdown agent, and an optional binder. In such embodiments, the coating may also comprise other things, but not more than small amounts (less than 10% of total solids) of ceramic or inorganic or organic heat resistant particles may be added. In some embodiments, the coating may comprise no ceramic, or organic, or organic heat resistant particles.

In some embodiments, the coated separator may have another coating that does comprise, consist of, or consist essentially of more than small amounts of ceramic or inorganic or organic heat resistant particles, but the layer that comprises, consists of, or consists essentially of an adhesion agent, a shutdown agent, and an optional binder does not contain more than small amounts of ceramic or organic or inorganic heat resistant particles, preferably nano-particles. For example, a ceramic coating may be provided on a side of the separator or membrane opposite the inventive coating or may be provided directly on top of the inventive coating. The term ceramic coating is well understood in the battery separator filed, particularly the secondary lithium battery separator filed, and may typically include ceramic particles in a binder or polymer matrix (such as made using organic solvent PVDF binder or aqueous acrylic binder and alumina or boehmite particles) with 50% or more, 75% or more, 90% or more, or 95% or more ceramic particles by volume or weight %, and, respectively 50% or less, 25% or less, 10% or less, or 5% or less binder or polymer matrix by volume or weight %. Today, many typical ceramic coatings have low binder adds and include over 80%, over 90%, or over 95% or more by weight ceramic, and, respectively, less than 20%, less than 10%, or less than 5% by weight binder or matrix (high ceramic content and low binder or polymer matrix content),In some embodiments, the coating may comprise, consist of, or consist essentially of an adhesion agent, a shutdown agent, an optional binder, and a small amount of an additional component. For example, the additional component may be at least one selected from the group of anti-statics, An anti-static may include an inorganic or ceramic particle such as carbon black, alumina, and/or the like.

In some embodiments, the adhesion agent may comprise, consist of, or consist essentially of at least one selected from the group of a dry adhesion agent, a wet adhesion agent, and a combination of the two. In some embodiments, the adhesion agent may comprise, consist of, or consist essentially of a wet adhesion agent. In some embodiments, the adhesion agent may comprise, consist of, or consist essentially of a dry adhesion agent. In some embodiments, the adhesion agent may comprise, consist of, or consist essentially of a wet adhesion agent and a dry adhesion agent. In some embodiments, the adhesion agent may comprise, consist of, or consist essentially of a PVDF.

In some embodiments, the shutdown agent may comprise, consist of, or consist essentially of beads or particles made of a polymer having a melting point from about 100° C. to about 140° C. In some embodiments, the shutdown agent may comprise, consist of, or consist essentially of PE beads. In some embodiments, the shutdown agent may comprise, consist of, or consist essentially of beads or particles made of a polymer having a melting point from about 130° C. to about 140° C.; beads or particles made of a polymer having a melting point from about 80° C. to about 130° C.; beads or particles having a melting point of 140° C. to 220° C., and combinations thereof. The beads or particles may have an average particle size of particle diameter from 0.5 to 3 microns.

In some embodiments, the separator is a separator consisting of or consisting essentially of polypropylene. In some embodiments, the separator consisting of or consisting essentially of polypropylene is a monolayer and/or a dry process separator. In some embodiments, the separator is a separator that does not have shutdown capability without the coating that comprises, consists of, or consists essentially of an adhesion agent and a shutdown agent. In some embodiments, the separator that does not have shutdown capability without the coating is a dry process separator.

In some embodiments, the coating may be on one side of the separator or porous film, and in other embodiments, it may be on two sides of the separator or porous film. Sometimes, the separator or porous film may comprise another coating that does contain ceramic or heat resistant particles.

In another aspect, a coated separator comprising a microporous film and a coating is described herein. The coated separator, in some embodiments, shuts down before it shrinks more than 15%, more than 12%, or more than 10% in at least a longitudinal or transverse dimension (length and/or width). In some embodiments where the coated separator shuts down before the separator shrinks more than 15%, more than 12%, or more than 10%, and such temperature is less than 130° C., less than 125° C., less than 120° C., less than115° C., or less than 110° C.

In some embodiments, the coating of the coated separator may comprise, consist of, or consist essentially of polyethylene and a binder. In some embodiments, the coating may further comprise, consist of, or consist essentially of inorganic fine particles in an amount of 10% or less or 5% or less of the total solids in the coating. The inorganic fine particles may comprise, consist of, or consists essentially of a metal oxide having a particle size D50 less than 500 nm, less than 250 nm or less or less than 200 nm or less. In some embodiments, the metal oxide may comprise, consist of, or consist essentially of alumina. The coating may be on one or both sides of the porous or microporous film and may be applied directly or indirectly (i.e., via an intervening layer) to the porous microporous film. For example, the intervening layer may be a ceramic layer in some embodiments.

In some embodiments, the porous microporous film may be a monolayer film. The monolayer film may comprise, consist of, or consist essentially of polypropylene. The microporous film may have an average porosity greater than 30%. The microporous film may have an average pore size greater than 0.03 microns, greater than 0.04 microns, greater than 0.045 microns, or greater. In some embodiments, the microporous film may be a bilayer, trilayer, or multilayer microporous film.

In another aspect, a secondary battery comprising at least one coated battery separator described herein is described.

In another aspect, a capacitor comprising the coated battery separator of coated porous membrane described herein is described.

In another aspect, a composite comprising a coated battery separator of coated porous membrane as described herein with an additional layer directly on top of the coating is described. In such embodiments, the coating may be one that comprises, consists of, or consists essentially of an adhesion agent. The coating may be one that comprises, consists of, or consists essentially of an adhesion agent and a binder. The coating may be one that comprises, consists of, or consists essentially of an adhesion agent, a binder, and inorganic or organic particles in small amounts. The coating may be a water-borne or water-based coating. The additional coating provided directly on top of the coating may be a ceramic coating, a polymer coating, a coating comprising, consisting of, or consisting essentially of electrode material, a coating comprising, consisting of, or consisting essentially of solid state electrolyte material, a metallic coating, a metal layer, a metal-containing coating, and/or the like.

### DESCRIPTION OF THE DRAWINGS

FIG. 1 is a schematic drawing of a one-side and two-side coated battery separator of coated membrane.

FIG. 2 is a shutdown profile according to some embodiments described herein.

FIG. 3 is a schematic drawing of a typical structure for a dry-process porous membrane

FIG. 4A and FIG. 4B are FSEM of typical dry process membranes as described herein.

FIG. 5 is a schematic drawing explaining the concept of tortuosity.

FIG. 6 is a schematic drawing of a typical lithium ion battery.

FIG. 7 is a schematic drawing of a coated separator or coated membrane according to some embodiments described herein.

FIG. 8 is a schematic drawing of a coated separator of coated membrane according to some embodiments described herein.

FIG. 9 includes schematic drawings of some coated separators or coated membranes according to some embodiments described herein.

FIG. 10 includes schematic drawings of some coated separators or coated membranes according to some embodiments described herein.

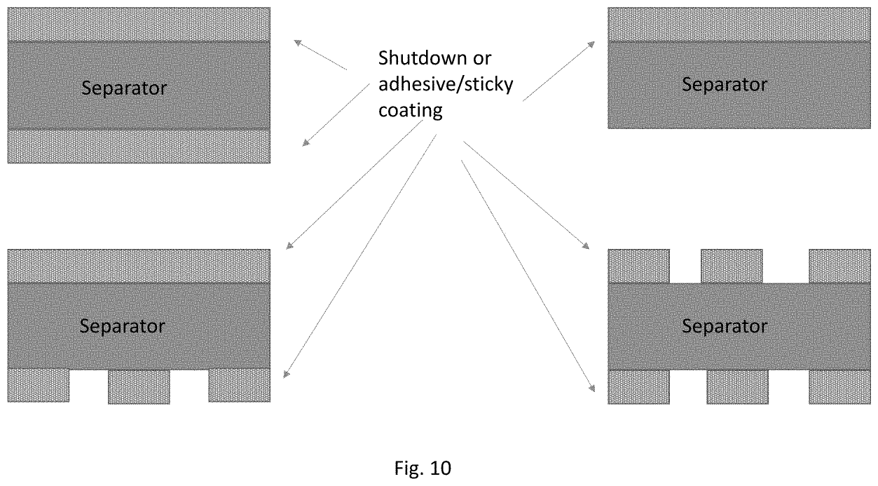

FIG. 11 includes SEMs of solvent-based and water-based or waterborne coatings according to some embodiments described herein. The SEMS highlight the uniformity of water-borne or water-based coatings.

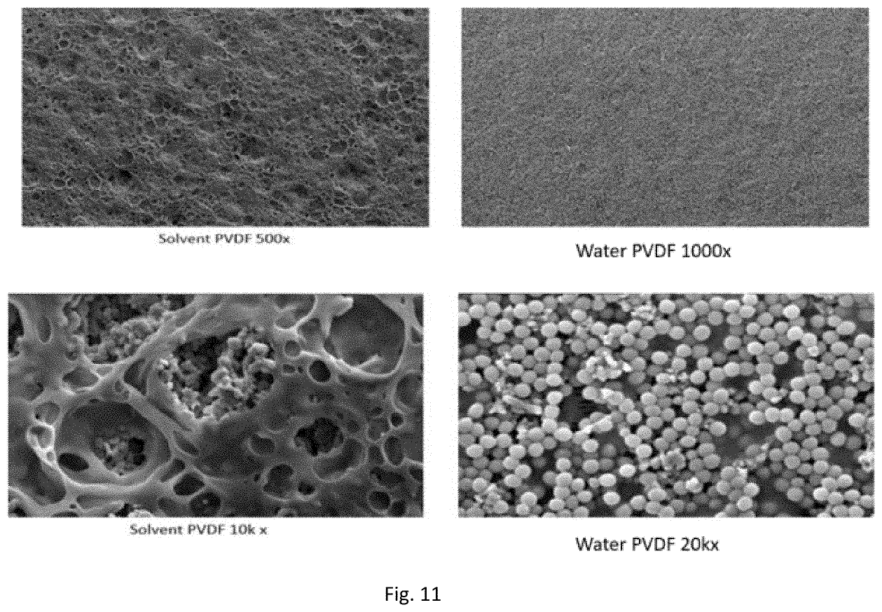

FIG. 12 is a graph showing self-adhesion of some embodiments described herein.

FIG. 13 is a schematic of a proposed mechanism to explain why self-adhesion is reduced in some embodiments described herein.

FIG. 14 is a graph showing shutdown profiles for some embodiments described herein.

FIG. 15 includes SEM images of some embodiments described herein.

FIG. 16 is a schematic drawing of some embodiments described herein.

### DETAILED DESCRIPTION

A coated separator or coated porous membrane is described herein. In preferred embodiments, the coated separator or coated porous membrane has a coating that comprises, consists of, or consists essentially of at least one selected from the group of an adhesion agent, a shutdown agent, and a binder. The coating does not comprise a ceramic or heat resistant material or comprises only a small amount of such material. In some preferred embodiments, the coating may comprise an adhesion agent, a shutdown agent, and one or more additional components. In other preferred embodiments, the coating may consist of or consist essentially of an adhesion agent and a shutdown agent. In some embodiments, the coating may comprise one of the following combinations: an adhesion agent; and adhesion agent and a binder; a shutdown agent; a shutdown agent and a binder; a shutdown agent and an adhesion agent; and a shutdown agent, an adhesion agent, and a binder. In any of the foregoing combinations, the adhesion agent may comprise the following: a wet adhesion agent or wet adhesion agents only; a dry adhesion agent or dry adhesion agents only; or a combination of at least one wet adhesion agent and at least on dry adhesion agent.

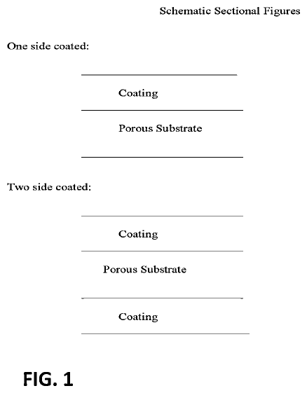

The coating may be provided on one side or on two sides of the separator or porous membrane. In some preferred embodiments where the coating is provide on two sides, the coating is provided on two opposing sides of the separator or porous membrane. This is shown in FIG. 1.

In some embodiments, the coated separator or coated porous membrane described herein may comprise a coating other than the coating comprising, consisting of, or consisting essentially of at least one selected from an adhesion agent, a shutdown agent, and a binder. For example, a two-side-coated separator may have the coating comprising, consisting of, or consisting essentially of at least one selected from an adhesion agent, a shutdown agent, and a binder on one side and a different coating on the other side. For example, the different coating may be a ceramic coating.

### Coating

The coating described herein may comprise, consist of, or consist essentially of at least one of (1) a shutdown agent and (2) an adhesion agent, and (3) a binder. In some preferred embodiments, the coating does not comprise ceramic or other heat-resistant inorganic or organic materials. In some embodiments, the coating may further comprise, consist of, or consist essentially of ceramic or other heat-resistant organic or inorganic materials in small amounts (less than about 10% or less than 5% total solids) for purposes such as providing anti-static effect. Though the coating described herein may comprise some amounts of ceramic or other organic or inorganic heat-resistant materials, the coating is not a typical ceramic coating, which may contain 90% or 95% or more by weight ceramic or other inorganic or organic heat resistant materials. In some embodiments, the coating may comprise the following: a shutdown agent; a shutdown agent and a binder; an adhesion agent; an adhesion agent and a binder; a shutdown agent and an adhesion agent; or a shutdown agent, an adhesion agent, and a binder. In any of the foregoing embodiments, the adhesion agent may comprise, consist of, or consist essentially of: only a wet adhesion agent or wet adhesion agents; only a dry adhesion agent or dry adhesion agents; or at least one dry adhesion agent and at least one wet adhesion agent.

In some other embodiments, the coating may comprise, consist of, or consist essentially of polyethylene shutdown agent or a polyethylene shutdown agent with a binder, and optionally inorganic fine particles. The polyethylene is not so limited, and may include any polyethylene including those described herein, particularly the lower melting temperature polyethylenes described herein. The binder is not so limited, and may be any binder described herein. The inorganic fine particles are not so limited and may be or include any of the inorganic materials described herein and others. The inorganic fine particles may be nanoparticles and have an average particle size less than about 500 nm, less than 450 nm, less than 400 nm, less than 350 nm, less than 300 nm, less than 250 nm, less than 225nm, less than 200nm, less than 175 nm, less than 150 nm, less than 125nm, or smaller. In some embodiments, the particle size may be greater than 250 nm and up to 1,000 nm. Smaller particle sizes have advantages in some embodiments described herein, particularly for shutdown coatings described herein and for some adhesion coatings described herein. For example, and without wishing to be bound by any particular theory, it is believed that inorganic fine particles may be preferred for a coating comprising a shutdown agent because the shutdown agent may more easily flow and block the pores of the separator or porous membrane resulting in shutdown. In some embodiments, the inorganic fine particles may comprise, consist of, or consist essentially of a metal oxide. In some embodiments, the metal oxide may be alumina or aluminum oxide. In some embodiments, the metal oxide may be another metal oxide other than alumina, including the metal oxides disclosed herein. The inorganic fine particle may be present in an amount less than 10% of the total solid content of the coating, less than 9% of the total solid content of the coating, less than 8% of the total solid content of the coating, less than 7% of the total solid content of the coating, less than 6% of the total solid content of the coating, less than 5% of the total solid content of the coating, less than 4% of the total solid content of the coating, less than 3% of the total solid content of the coating, less than 2% of the total solid content of the coating, or less than 1% of the total solid content of the coating.

The coating may have a thickness of 0.5 to 10 microns, 0.5 to 9 microns, 0.5 to 8 microns, 0.5 to 7 microns, 0.5 to 6 microns, 0.5 to 5 microns, 0.5 to 4 microns, 0.5 to 3 microns, or 0.5 to 2 microns. In some preferred embodiments, the coating may be from about 1 to about 2 microns thick. In some embodiments, the coating may be a monolayer.

The coating may be provide using any known methods. It may also be formed by a co-extrusion process where the separator and coating are co-extruded together.

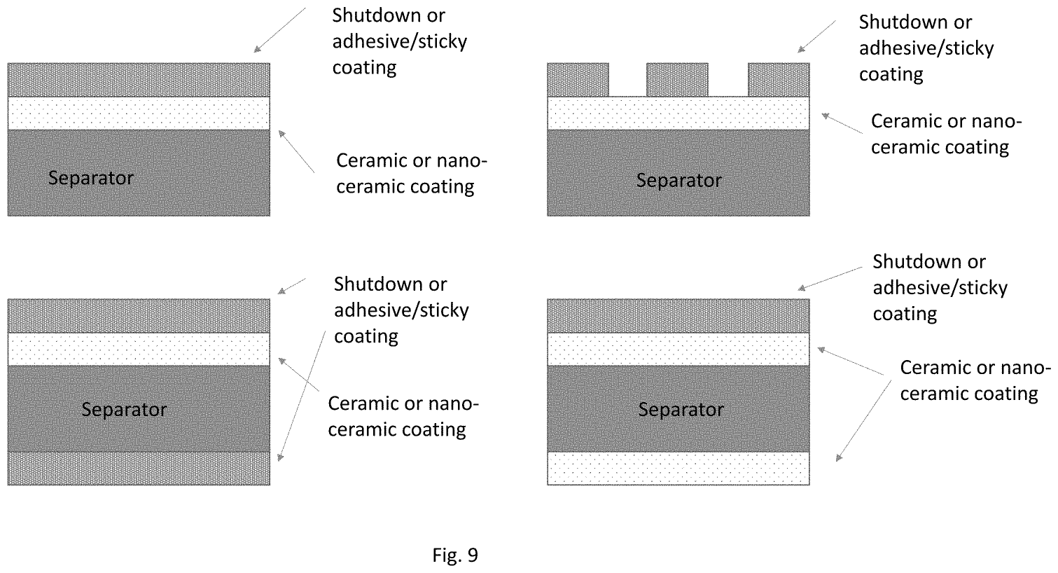

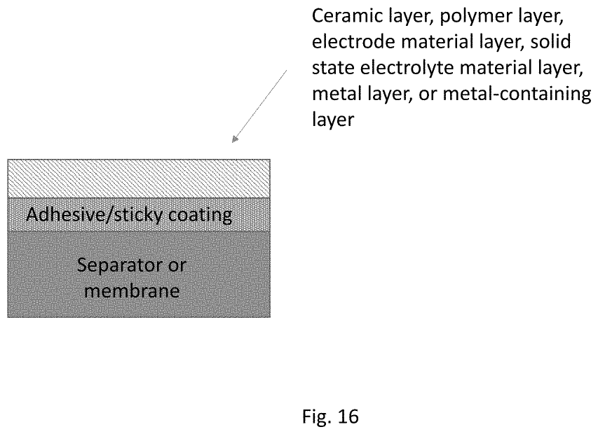

In some preferred embodiments, the coating is provided directly onto the surface of the separator, but in some embodiments, an intervening layer may be provided between the separator and the coating. For example, FIG. 9 shows examples with an intervening ceramic layer. Another layer or other layers may be provided on top of the coating. For example, a layer comprising inorganic or organic heat resistant particles may be provided on top of the layer. Further, a ceramic layer, a layer comprising electrode material, a layer comprising solid state electrolyte material, a metal layer, a metal-containing layer, or the like may be provided directly on top of the coating. This is shown in FIG. 16. In FIG. 16, the coating is preferably and adhesive or sticky coating, but the coating may also comprise a shutdown agent and/or organic or inorganic particles, including nano-particles

The size, shape, chemical composition, etc. of these heat-resistant particles is not so limited. The heat-resistant particles may comprise an organic material, an inorganic material, e.g., a ceramic material, or a composite material that comprises both an inorganic and an organic material, two or more organic materials, and/or two or more inorganic materials.

In some embodiments, heat-resistant means that the material that the particles are made up of, which may include a composite material made up of two or more different materials, does not undergo substantial physical changes, e.g., deformation, at temperatures of 200° C. Exemplary materials include aluminum oxide (Al₂O₃), silicon dioxide (SiO₂), graphite, etc.

Non-limiting examples of inorganic materials that may be used to form the heat-resistant particles disclosed herein are as follows: iron oxides, silicon dioxide (SiO₂), aluminum oxide (Al₂O₃), boehmite (Al(O)OH), zirconium dioxide (ZrO₂), titanium dioxide (TiO₂), barium sulfate (BaSO₄), barium titanium oxide (BaTiO₃), aluminum nitride, silicon nitride, calcium fluoride, barium fluoride, zeolite, apatite, kaoline, mullite, spinel, olivine, mica, tin dioxide (SnO₂), indium tin oxide, oxides of transition metals, graphite, carbon, metal, and any combinations thereof.

Non-limiting examples of organic materials that may be used to form the heat-resistant particles disclosed herein are as follows: a polyimide resin, a melamine resin, a phenol resin, a polymethyl methacrylate (PMMA) resin, a polystyrene resin, a polydivinylbenzene (PDVB) resin, carbon black, graphite, and any combination thereof.

The heat-resistant particles may be round, irregularly shaped, flakes, etc. The average particle size of the heat-resistant material ranges from 0.01 to 5 microns, from 0.03 to 3 microns, from 0.01 to 2 microns, from 0.5 to 3 microns, etc.

In some preferred embodiments, the coating may be a waterborne or water-based coating. Water-borne means that the coating is formed from a coating slurry where the solvent is water alone or water and an alcohol or other non-organic water-soluble solvent. For example, the water-borne or water-based coating may include a solvent that is water and up to 50% of an alcohol or non-organic water-soluble solvent such as PVA. In some embodiments, the coating may be a solvent-borne coating. A solvent-borne coating is formed from a slurry where the solvent is an organic solvent. Sometimes the solvent is present with the binder used. Most solvent is removed from a coating after it is formed from the coating slurry.

(1) Shutdown Agent

The shutdown agent is not so limited. In some embodiments, the shutdown agent may be capable of providing at least one of the following functions: (1) impart low temperature (e.g., less than 135° C.) shutdown capability to a separator that has no low temperature shutdown capability without the coating, (2) lower the shutdown initiation temperature of a separator that does have low temperature shutdown capability, and (3) extending the shutdown window of a separator that has low temperature shutdown capability. All of the shutdown agents described herein may be used on separators with or without low temperature shutdown capabilities even though certain uses may be preferred over others.

Regarding the use of the shutdown agents disclose herein, it may be preferable to use the shutdown agents that impart low temperature shutdown on a separator that does not itself exhibit a low temperature shutdown function. However, shutdown agents that lower the shutdown initiation temperature or extend the shutdown window may also be used to provide an extended shutdown window. An example of a separator that does exhibit a low temperature shutdown function may be found in Celgard U.S. Pat. No. 5,952,120, which is incorporated by reference herein in its entirety. In that document, shutdown is provided at least in part by the melting of the polyethylene-containing middle layer of the trilayer. In such shutdown trilayers, because the PE shutdown also contributes to the strength of the film, there is typically a lower limit to the melting point and molecular weight of the polyethylene used. Lower molecular weight (and thus lower melting point) typically are not used because they do not provide the same mechanical strength as higher molecular weight (and higher melting point) polyethylenes. However, when shutdown is provided in the coating as is done here, lower molecular weight (and thus lower melting point) polyethylene can be used as the shutdown agent of the coating it is not necessarily providing mechanical strength to the separator. The coating herein could also be provided to a shutdown trilayer as disclosed in Celgard® U.S. Pat. No. 5,952,120, providing a “double shutdown” effect where shutdown may begin occurring at the melting point of the shutdown agent, which is typically lower than that of the polymer used in the shutdown layer of the shutdown trilayer. By providing a lower shutdown capability to the separator, the safety of the battery it is used in is improved. For example, thermal runaway may better be prevented.

In some embodiments the shutdown agent may be in the form of particulates or beads. The particulates or beads may have an average particle size from 0.1 to 3 microns, from 0.1 to 2 microns, from 0.1 to 1.5 microns, from 0.1 to 1.0 microns, from 0.5 to 3.0 microns, or from 0.1 to 0.5 microns. The particles or beads may be symmetrically, asymmetrically, spherically, or aspherically shaped.

In embodiments where the shutdown agent is capable of providing low temperature shutdown capability to a separator that has no low temperature shutdown capability without the coating, the shutdown agent may comprise, consist of, or consist essentially of a polymer having a melting point of about 135° C. or below. In some embodiments, the polymer may have a melting point below about 130° C., below about 125° C., below about 120° C., below about 115° C., below about 110° C., below about 105° C., below about 100° C., below about 95° C., or below about 90° C. In some embodiments, the polymer may have a melting point in the range of 80° C. to 135° C. In some embodiments, the shutdown agent may comprise, consist of, or consist essentially of beads of the polymer. In some preferred embodiments, the shutdown agent may comprise, consist of, or consist essentially of polyethylene beads.

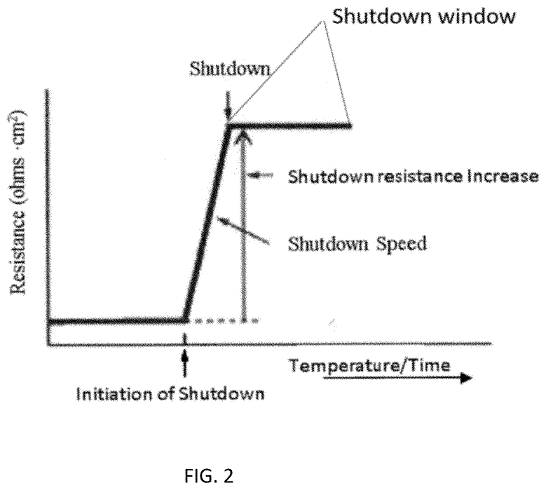

In embodiments where the shutdown agent lowers the shutdown initiation temperature of the separator, the separator will exhibit a shutdown profile similar to that shown in FIG. 2.

In such embodiments, the shutdown agent will have a melting point lower than the initiation of shutdown temperature or lower than a value that is with 1 or 2 or 3 degrees of the initiation of shutdown temperature of the separator itself. For example, the shutdown agent may comprise, consist of, or consist essentially of a polymer having a melting point from 80° C. to a value less than the initiation of shutdown temperature measured for the separator itself, i.e., without a coating. Alternatively, the shutdown agent may comprise, consist of, or consist essentially of a polymer having a melting point from 80° C. to a temperature within 1, or 2, or 3 degrees of the shutdown initiation temperature of the separator itself. Exemplary materials may include particles or beads comprising wax, oligomer, polyethylene (PE), for example low-density PE, and/or the like. These particles may be coated, uncoated, or partially coated.

In embodiments where the shutdown agent extends the shutdown window of a separator that has shutdown capability, the separator will exhibit a shutdown window as shown in FIG. 2. In such embodiments, the shutdown agent may comprise a polymer with a melting point that is higher than the shutdown temperature. For example, in these embodiments, the shutdown agent may have a melting temperature above 135° C. For example, the shutdown agent may have a melting point in the range of 140° C. to 220° C., sometimes in the range of 150° C. to 200° C., sometimes in the range of 160° C. to 190° C., sometimes in the range of 170° C. to 180° C., etc.

(2) Adhesion Agent

The adhesion agent described herein is not so limited. In some embodiments, the adhesion agent is at least one selected from the group of a wet adhesion agent, a dry adhesion agent, and a combination thereof.

In some embodiments, the adhesion agent is in the form of beads or particles and having an average particle size from 0.1 to 3 microns, from 0.1 to 2 microns, from 0.1 to 1.5 microns, from 0.1 to 1.0 microns, from 0.5 to 3 microns, or from 0.1 to 0.5 microns. Beads or particles may be spherically, symmetrically, or asymmetrically shaped.

In some preferred embodiments, the wet adhesion agent may comprise, consist of, or consist essentially of a wet adhesion polymer. The wet adhesion polymer as described herein is not so limited and may be any polymer that absorbs electrolyte, swells or grows in size when it absorbs electrolyte, and/or becomes gel-like when it absorbs electrolyte. The electrolyte may be any electrolyte suitable for use in a secondary battery, which may include but is not limited to electrolytes where the solvent is DEC, PC, DMC, EC, or combinations thereof. A wet adhesion polymer will also increase adhesion of the coating, when wet with electrolyte, to the anode or cathode of a secondary battery.

In some embodiments, the wet adhesion polymer may comprise, consist of, or consist essentially of a fluoropolymer. In some embodiments, the fluoropolymer is a PVDF such as PVDF-HFP. The HFP content of PVDF-HFP may be from 1 to 50% by weight based on the total weight of the polymer. In some embodiments it may be from 1 to 40% by weight, from 1 to 30% by weight, from 1 to 20% by weight, from 1 to 15% by weight, from 1 to 10% by weight, or from 1 to 5% by weight.

In some embodiments, the wet adhesion polymer may comprise, consist of, or consist essentially of methyl (meth)acrylate, ethyl (meth)acrylate, n-propyl (meth)acrylate, isopropyl (meth)acrylate, n-butyl (meth) acrylate, t-butyl (meth)acrylate, sec-butyl (meth)acrylate, pentyl (meth)acrylate, 2-ethylbutyl (meth)acrylate, 2-ethylhexyl (meth)acrylate, n-octyl (meth)acrylate, isooctyl (meth)acrylate, isononyl (meth)acrylate, lauryl (meth)acrylate, tetradecyl (meth)acrylate, polyvinylidene difluoride (PVDF), poly(vinylidene fluoride-co-hexafluoropropylene) (PVDF:HFP), polytetrafluoroethylene (PTFE), polyethylene oxide (PEO), poly(vinyl alcohol) (PVA), polyacrylonitrile (PAN), polyacrylamide, polyvinylacetate, polyvinylpyrrolidone, polytetraethylnene glycol diacrylate, a polypropylene (PP) including isotactic PP, high density PP, ultrahigh molecular weight PP, low density PP, a polyethylene (PE) including high density PE, ultrahigh molecular weight PE, low density PE, polyvinyl acetate, polyvinyl chloride, bisphenol-A polycarbonate (BPA-PC), cyclo-olefinic copolymer (COC), a polysulfone (PSF), polyether imide (PEI), polyurethane, acrylonitrile butadiene styrene (ABS), copolymers of any of the foregoing, or any combination thereof.

Use of wet adhesion polymers may be useful in a battery where adhesion to the electrodes are important.

In some preferred embodiments, the adhesion agent is, consists of, or consists essentially of a wet adhesion polymer as described herein. In some preferred embodiments, a PVDF is the wet adhesion polymer. In some embodiments, the wet adhesion polymer is an acrylic polymer.

In some preferred embodiments, the dry adhesion agent may comprise, consist of, or consist essentially of a dry adhesion polymer. A dry adhesion polymer as described herein is not so limited and is any polymer that imparts high or low tack to the coating. A high tack coating is harder to separate after being brought into contact with another surface with which a bond is formed. A lower tack coating is easier to separate and reposition after being brought into contact with another surface with which a bond is formed. Coatings with tack may be beneficial for battery separators used in stacked-type or prismatic-type battery cells, for example. It helps prevent the separator from moving once in its proper position in the cell.

The dry adhesion polymer described herein may be characterized by its glass transition temperature. In some embodiments, the dry adhesion polymer has a glass transition temperature less than 100° C., less than 90° C., less than 80° C., less than 70° C., less than 60° C., less than 50° C., less than 40° C., less than 30° C. or less than 20° C. A minimum glass transition temperature may be 20° C., 10° C., 5° C., or 0° C. Preferably, in some embodiments, the glass transition temperature may be from 20° C. to 100° C., or from 20° C. to 70° C., or from 25° C. to 100° C. In some embodiments, the dry adhesion polymer has a glass transition temperature less than 100° C., less than 90° C., less than 80° C., or less than 70° C. In some preferred embodiments, the glass transition temperature of the dry adhesion polymer is between 30° C. and 80° C., between 40° C. and 70° C., between 40° C. and 65° C., between 45° C. and 60° C., between 45° C. and 55° C., or between 45° C. and 50° C.

Some non-limiting examples of dry adhesion polymer may be a PVDF-HFP copolymer or an acrylic having a glass transition temperature as described above. In some embodiments, the HFP content in the PVDF-HFP may be from 1 to 50%, from 1 to 40%, from 1 to 30%, from 1 to 20%, from 1 to 10%, or from 1 to 5% by weight based on the total weight of the polymer. In some embodiments, the dry adhesion polymer may be an acrylic polymer.

In embodiments where the adhesion agent include a dry adhesion polymer and a wet adhesion polymer, the benefits of using these types of polymers (e.g., adhesion to electrodes or electrode and ease of manufacturing a stacked-type or prismatic-type cell) may be realized. In some embodiments, a ceramic coating, an electrode material, a metal, a metallic material, or a solid state electrolyte material may be applied directly to a coating comprising an adhesion agent.

(3) Binder

The binder is not so limited.

In some embodiments, the binder may be an acrylic. In some embodiments, the binder may be a polymeric binder comprising, consisting of, or consisting essentially of a polymeric, oligomeric, or elastomeric material and the same are not limited. Any polymeric, oligomeric, or elastomeric material not inconsistent with this disclosure may be used. The binder may be ionically conductive, semi-conductive, or non-conductive. Any gel-forming polymer suggested for use in lithium polymer batteries or in solid electrolyte batteries may be used. For example, the polymeric binder may comprise at least one, or two, or three, etc. selected from a polylactam polymer, polyvinyl alcohol (PVA), Polyacrylic acid (PAA), Polyvinyl acetate (PVAc), carboxymethyl cellulose (CMC), an isobutylene polymer, an acrylic resin, a latex, an aramid, or any combination of these materials.

In some preferred embodiments, the polymeric binder comprises, consists of, or consists essentially of a polylactam polymer, which is a homopolymer, co-polymer, block polymer, or block co-polymer derived from a lactam. In some embodiments, the polymeric material comprises a homopolymer, co-polymer, block polymer, or block co-polymer according to formula (1).

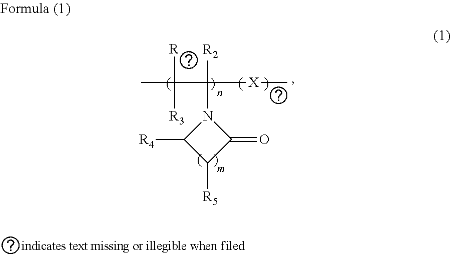

wherein R₁, R₂, R₃, and R₄ can be alkyl or aromatic substituents and R₅ can be an alkyl substituent, an aryl substituent, or a substituent comprising a fused ring; and wherein the preferred polylactam can be a homopolymer or a co-polymer where co-polymeric group X can be derived from a vinyl, a substituted or un-substituted alkyl vinyl, a vinyl alcohol, vinyl acetate, an acrylic acid, an alkyl acrylate, an acrylonitrile, a maleic anhydride, a maleic imide, a styrene, a polyvinylpyrrolidone (PVP), a polyvinylvalerolactam, a polyvinylcaprolactam (PVCap), polyamide, or a polyimide; wherein m can be an integer between 1 and 10, preferably between 2 and 4, and wherein the ratio of 1 to n is such that 0≤:n≤10 or 0≤:n≤1. In some preferred embodiments, the homopolymer, co-polymer, block polymer, or block co-polymer derived from a lactam is at least one, at least two, or at least three, selected from the group of polyvinylpyrrolidone (PVP), polyvinylcaprolactam (PVCap), and polyvinyl-valerolactam.

In another preferred embodiment, the polymeric binder comprises, consists of, or consists essentially of polyvinyl alcohol (PVA). Use of PVA may result in a low curl coating layer, which helps the substrate to which is it applied stay stable and flat, e.g., helps prevent the substrate from curling. PVA may be added in combination with any other polymeric, oligomeric, or elastomeric material described herein, particularly if low curling is desired.

In another preferred embodiment, the polymeric binder may comprise, consist of, or consists essentially of an acrylic resin. The type of acrylic resin is not particularly limited, and may be any acrylic resin that would not be contrary to the goals stated herein, e.g., providing a new and improved coating composition that may, for example, be used to make battery separators having improved safety. For example, the acrylic resin may be at least one, or two, or three, or four selected from the group of polyacrylic acid (PAA), polymethylmethacrylate (PMMA), polyacrylonitrile (PAN), polymethyl acrylate (PMA).

In other preferred embodiments, the polymeric binder may comprise, consist of, or consist essentially of carboxymethyl cellulose (CMC), an isobutylene polymer, latex, or any combination these. These may be added alone or together with any other suitable oligomeric, polymeric, or elastomeric material.

In some embodiments, the polymeric binder may comprise a solvent that is water only, an aqueous or water-based solvent, and/or a non-aqueous solvent. When the solvent is water, in some embodiments, no other solvent is present. The aqueous or water-based solvent may comprise a majority (more than 50%) water, more than 60% water, more than 70% water, more than 80% water, more than 90% water, more than 95% water, or more than 99%, but less than 100% water. The aqueous or water-based solvent may comprise, in addition to water, a polar or non-polar organic solvent. The non-aqueous solvent is not limited and may be any polar or non-polar organic solvent compatible with the goals expressed in this application. In some embodiments, the polymeric binder comprises only trace amounts of solvent, and in other embodiments it comprises 50% or more solvent, sometimes 60% or more, sometimes 70% or more, sometimes 80% or more, etc.

The amount of binder, in some preferred embodiments, may be less than 20%, less than 15%, less than 10%, or less than 5% of the total solids in the coating. In some particularly preferred embodiments, the amount of binder may be 10% or less, or 5% or less of the total solids in the coating.

### Separator or Porous Membrane

The battery separator (uncoated) or the porous membrane described herein is not so limited and any battery separator or porous membrane may be used. For example, the separator or porous membrane may be a monolayer, bilayer, trilayer, or multilayer separator or porous membrane made by any type of process, including dry processes and wet processes known in the art.

In preferred embodiments, the separator is porous, nanoporous, microporous, or macroporous. In some particularly preferred embodiments, the separator is microporous. For example, the separator may have an average pore size between 0.1 and 1.0 microns.

In some preferred embodiments, the separator or membrane is one that does not itself have shutdown capability. For example, the separators do not have shutdown capability at temperatures below 160° C., below 150° C., or below 140° C. For example, in some embodiments, the separator is not a trilayer shutdown separator as disclosed in Celgard U.S. Pat. No. 5,952,120. However, in some embodiments, the separator itself may have shutdown capabilities (e.g., at temperatures below 160° C., below 150° C., or below 140° C.) and the coating may be used to lower the shutdown initiation temperature or extend the shutdown window.

In some preferred embodiments, the separator is a monolayer separator.

In some preferred embodiments, the battery separator described herein is a dry-process battery separator or membrane.

A dry-process, in some embodiments, is a process that does not use any pore-forming agent/pore-former, or beta-nucleating agent/beta-nucleator. In some embodiments, a dry-process is one that does not use any solvent, wax, or oil. In some embodiments, a dry-process is one that does not use any pore-forming agent/pore former, or beta-nucleating agent/beta-nucleator, and also does not use any solvent, wax, or oil. In such embodiments, the dry process may be a dry-stretch process. An exemplary dry-stretch process known as the Celgard dry stretch process is described in Chen et al., Structural Characterization of Celgard® Microporous Membrane Precursors:Melt-Extruded Polyethylene Films, J. of Applied Polymer Sci., vol. 53, 471-483 (1994), which is incorporated by reference herein in its entirety. The Celgard dry stretch process refers to a process where pore formation results from stretching a nonporous oriented precursor at least in the machine direction. Kesting, Robert E., Synthetic Polymeric Membranes, A Structural Perspective, Second Edition, John Wiley & Sons, New York, N.Y., (1985), pages 290-297, also discloses a dry-stretch process and is incorporated herein by reference in its entirety. In a dry-stretch process according to some preferred embodiments, the process may comprise a stretching step. The stretching step may comprise, consist of, or consist essentially of uniaxial stretching (e.g., stretching in only the MD direction or in only the TD direction), biaxial stretching (e.g., stretching in the MD and TD direction), or multi-axial stretching (e.g., stretching along three or more different axes such as MD, TD, and another axis). In some embodiments, the dry-stretch process may comprise, consist of, or consist essentially of an extrusion step and a stretching step, in that order or not in that order. In some embodiments, the dry stretch process may comprise, consist of, or consist essentially of an extrusion step, an annealing step, and a stretching step, in that order or not in that order. The extrusion step, in some embodiments, may be a blown-film extrusion step or a cast-film extrusion process. In some embodiments, a non-porous precursor is extruded and stretched to form pores. In some embodiments, a non-porous precursor is extruded, annealed, and then stretched to form pores. In other embodiments, a porous or non-porous precursor may be formed by a method other than extrusion, such as by sintering or printing, and stretching may be performed on the precursor to form pores or to make existing pores larger.

In some embodiments, pore-forming agent/pore former, or beta-nucleating agent/beta-nucleator may be used and the process is still considered a dry-process. For example, a particle stretch process may be considered to be a dry process because oil or solvent is not extruded with the polymer and extracted from the extruded polymer to form pores. In a particle stretch process, particles such as silica or calcium carbonate are added to a polymer mixture, and these particles help to form the pores. In such a method, for example, the polymer mixture comprising particles and a polymer is extruded to form a precursor that is stretched and voids are created around the particles. In some embodiments, the particles may be removed after the voids are created. While a particle stretch process may include a stretching step before or after the removal of the particles, a particle stretch process is not considered a dry-stretch process because the principle pore formation mechanism is the use of the particles not stretching.

In some preferred embodiments, the structure of a dry-process porous membrane may have one or more distinguishing features. For example, a dry-process membrane may comprise an amount of polypropylene greater than 10%. Wet-processes or other processes using a solvent are not generally compatible with polypropylene because the solvents degrade polypropylene. Thus, wet process porous membranes typically contain no more than 10% polypropylene, and most typically 5% or less. One other distinguishing feature of some dry process porous membranes, particularly those used as battery separators, is the ability to have a shutdown function. Shutdown function may be imparted, in some cases, by a PP/PE/PP structure. This is unique to dry-process membranes because layers comprising mainly polypropylene (PP) generally cannot be formed in a wet process. A dry process is uniquely suited to form a PP/PE/PP shutdown membrane structure.

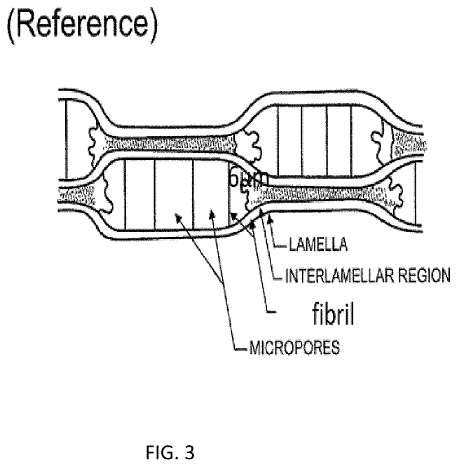

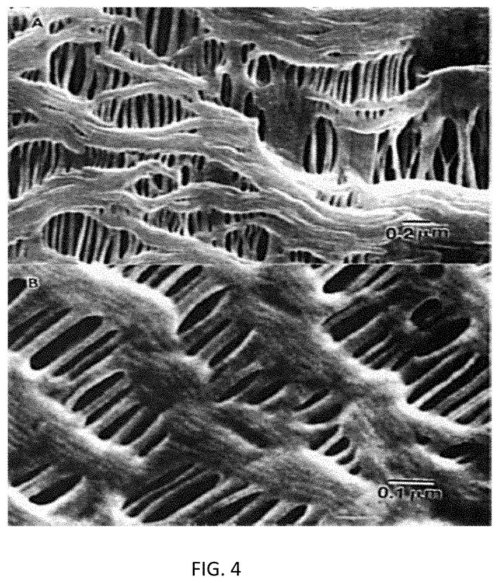

In some embodiments, a distinguishing dry-process porous membrane may have the presence of lamellae and fibrils shown in FIG. 3. For example, the porous membrane may have a structure like that shown in FIG. 3 or FIGS. 4A and 4B. FIGS. 4A and 4B are FESM images showing slit-like micropores in Celgard® microporous membranes comprising PE (A) and PP(B). In some embodiments, the pores or micropores of a dry-process porous membrane may be round, oblong, semi-round, trapezoidal, etc.

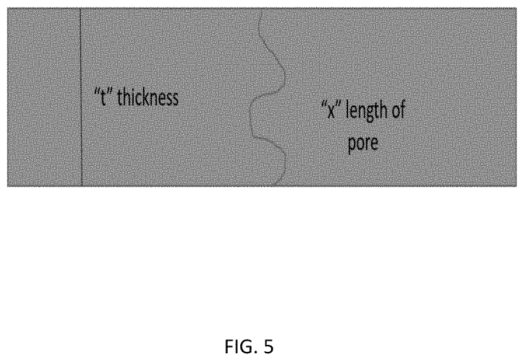

In some embodiments, a distinguishing feature of a dry-process porous membrane is that it contains no or substantially no pin-holes. Pin-holes are considered a defect, and generally are not an intentionally formed feature of a dry-process porous membrane. In some embodiments, the dry-process microporous membrane may contain no or substantially no pin-holes greater than 10 nm. In some preferred embodiments, the pores of a dry-process porous membrane are tortuous. In some embodiments, a distinguishing feature of a dry-process porous membrane is tortuosity. In some embodiments, the tortuosity of a dry-process porous membrane is greater than 1, greater than 1.2, greater than 1.3, greater than 1.4, greater than 1.5, greater than 1.6, greater than 1.7, greater than 1.8, greater than 1.9, or greater than 2.0. In some embodiments, a formula for calculating tortuosity crudely is formula (2):

$$Tortusosity = x / t \qquad ( 2 )$$

where “x” is the length of the opening or pore in a porous membrane and “t” is the thickness of the membrane. A pin-hole has a tortuosity of 1 because the length of the pin hole is the same as the thickness of the membrane. A tortuous pore has a tortuosity greater than 1 as shown in FIG. 5 because the length of the pore is longer than the thickness of the membrane.

In some embodiments, the dry-stretch porous membrane is semi-crystalline. In some embodiments, the dry-stretch porous membrane is semi-crystalline and oriented in a single direction. For example, the membrane may be MD-oriented. A porous film formed by a wet process, such as a film formed by a beta-nucleation process, may be randomly oriented.

### Composite or Device

A composite or device comprising any coated battery separator or coated porous membrane as described hereinabove and one or more electrodes, e.g., an anode, a cathode, or an anode and a cathode, provided in indirect or in direct contact therewith. The type of electrodes are not so limited. For example the electrodes can be those suitable for use in a lithium ion secondary battery.

In some embodiments, the composite or device is a cell selected from at least one of the following: a cylindrical cell, a pouch cell, a prismatic cell, a wound cell, a folded cell, a wrapped cell, a pocket cell or a stacked cell.

In some embodiments, the composite or device is a secondary battery such as a lithium-ion battery.

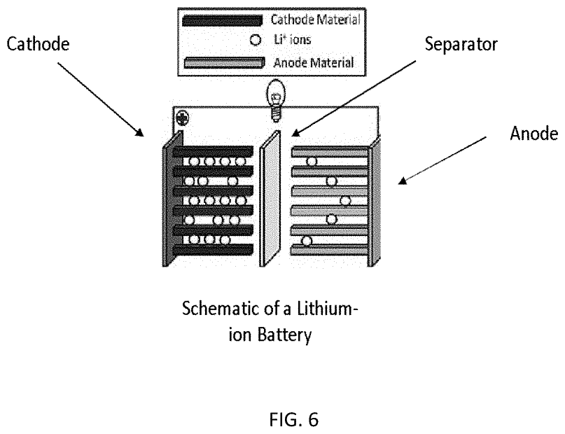

A lithium-ion battery according to some embodiments herein is shown in FIG. 6.

A suitable anode may have an energy capacity greater than or equal to 372 mAh/g, preferably ≥700 mAh/g, and most preferably ≥1000 mAH/g. The anode be constructed from a lithium metal foil or a lithium alloy foil (e.g. lithium aluminum alloys), or a mixture of a lithium metal and/or lithium alloy and materials such as carbon (e.g., coke, graphite), nickel, copper. The anode is not made solely from intercalation compounds containing lithium or insertion compounds containing lithium.

A suitable cathode may be any cathode compatible with the anode and may include an intercalation compound, an insertion compound, or an electrochemically active polymer. Suitable intercalation materials includes, for example, MoS₂, FeS₂, MnO₂, TiS₂, NbSe₃, LiCoO₂, LiNiO₂, LiMn₂O₄, V₆O₁₃, V₂O₅, and CuCl₂. Suitable polymers include, for example, polyacetylene, polypyrrole, polyaniline, and polythiopene.

Any battery separator described hereinabove may be incorporated to any vehicle, e.g., an e-vehicle, or device, e.g., a cell phone or laptop, that is completely or partially batter, powered. Various embodiments of the invention have been described in fulfillment of the various objects of the invention. It should be recognized that these embodiments are merely illustrative of the principles of the present invention. Numerous modifications and adaptations will be readily apparent to those skilled in the art without departing from the spirit and scope of this invention.

In some aspects, a capacitor comprising at least one coated separator as described herein is disclosed. In some embodiments, the capacitor may be a supercapacitor.

In some embodiments, a coated battery separator of coated porous membrane as described herein with an additional layer directly on top of the coating is described. In such embodiments, the coating may comprise, consist of, or consist essentially of at least an adhesion agent. In some preferred embodiments, the coating may be a waterborne or water-based coating. Such coatings have excellent uniformity, and so are ideal for applying another coating directly on top of. For example, the adhesiveness of the coating may be uniform. The layer provided directly on top may be at least one of a ceramic coating, a coating or layer of electrode material, a coating or layer of solid state electrolyte material, a metallic layer or coating, a metal-containing coating or layer, a metal layer or coating, and the like.

### EXAMPLES

### Example 1

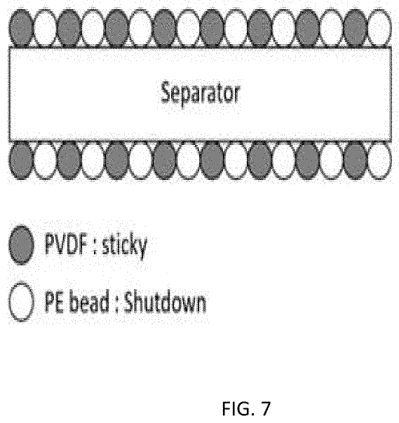

In Example 1, a monolayer separator (porous membrane) made of polypropylene was coated with a coating slurry or mixture comprising PVDF as an adhesion agent and PE beads as a shutdown agent. In this embodiment, a binder was used for Example la and no binder was used for Example 1b. In Example 1b, the PVDF and PE were dispersed in water or a water-based solvent that may contain up to 50% alcohol or other water-soluble solvent. The coating in la was also a water-borne, aqueous, or water-based coating. The coating was applied to one or both sides (could also be one side) of the separator (porous membrane). A schematic picture of the two-side coated separator according to Example 1 is in FIG. 7. The separator (porous membrane in Example 1 did not have shutdown capability by itself.

### Example 2

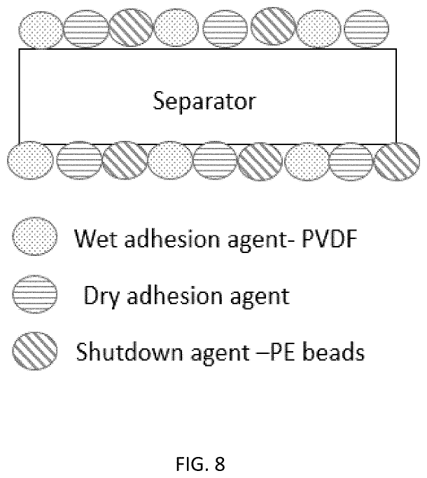

In Example 2, a monolayer separator made of polypropylene was coated with a coating, slurry or mixture comprising PVDF as a wet adhesion agent, a dry adhesion agent, and PE beads as a shutdown agent. A binder was used in Example 2a, but no binder was used in Example 2b. In Example 2b, the PVDF as a wet adhesion agent, a dry adhesion agent, and PE beads as a shutdown agent were dispersed in water or in a water-based solvent having up to 50% of an alcohol or another water-soluble solvent. The coating in 2a was also a water-based or water-borne coating. The coating was applied to one or both sides of the separator. A schematic picture of the two-side coated separator according to Example 2 is in FIG. 8. The separator in Example 1 did not have shutdown capability by itself.

Examples 3-202 contain the amounts of adhesion agents and shutdown agents shown in the Table below. Binder is added with a solvent, which may be water or water-based or an organic solvent, in each Example where an “X” is present in the “Binder” column. Binder is added in an amount not exceeding 10% of the total solids in the coating. In some embodiments, a binder is not added, and for example, the adhesion agents, shutdown agents, and/or the inorganic or heat resistant particles may be dispersed in an organic solvent or in water or a water-based solvent without a binder. A water-based solvent may comprise up to 50% of an alcohol or another solvent that is soluble in water. Inorganic or heat resistant particles were added in each Example where an “X” is present in the “Inorganic or heat resistant particles” column. A dash (“-”) means a component is not present in the coating of that Example. Examples 3-202 are all two-side-coated separators with the same coating on each side of a porous membrane (separator) such as a polypropylene monolayer membrane (separator). Two side-coated separators were also prepared where one of the coatings is a ceramic coating and the other coating has a composition like that in Examples 3-238. Exemplary one-side coated separators were also prepared where one coating is applied and the composition of the coating corresponded to the coating composition used in Examples 3-238. Additionally, embodiments like those in Examples 3-238 were prepared where the inorganic or organic heat resistant particles were nanoparticles (particle size less than about 500 nm, less than 450 nm, less than 400 nm, less than about 350 nm, less than about 300 nm, 250 nm or less than 200 nm) and non-nanoparticles (particle size above 250nm, above, 300 nm, above, 350 nm, above 400 nm, above 450 nm, or above 500nm and up to 1,000 nm). Finally, Examples like Examples 3-238 were formed where the coating was formed on top of a ceramic or nano-ceramic layer. The coating may be formed continuously or non-continuously on the ceramic or nano-ceramic layer. A ceramic or nano-ceramic layer as described herein is a layer comprising 80%, 85% or more, 90% or more, 95% or more, or 98% or more by weight of ceramic or nano-ceramic, and optionally a binder or other additives. All of the embodiments described herein were made using water as the solvent to form a water-based or water-borne coating solution that was then coated. Embodiments were also made using a solvent-based coating solution. Water-borne means that the solvent is water alone or water and an alcohol or other non-organic water-soluble solvent. For example, the water-borne or water-based coating may include a solvent that is water and up to 50% if an alcohol or non-organic water-soluble solvent such as PVA.

| | | | | | | | | Inorganic or |
|---|---|---|---|---|---|---|---|---|
| | Wet | | Dry | | | | | organic heat |
| | adhesion | | Adhesion | | Shutdown | | | resistant |
| | Agent | | Agent | | agent | | Binder | particles |
| Example 3 | 0.1 | parts | — | | 1 | part | X | X |
| Example 4 | 0.25 | parts | — | | 1 | part | X | X |
| Example 5 | 0.5 | parts | | | 1 | part | X | X |
| Example 6 | 0.75 | parts | — | | 1 | part | X | X |
| Example 7 | 1 | part | — | | 1 | part | X | X |
| Example 8 | 1.5 | parts | — | | 1 | part | X | X |
| Example 9 | 2 | parts | — | | 1 | part | X | X |
| Example 10 | 2.5 | parts | — | | 1 | part | X | X |
| Example 11 | 3 | parts | — | | 1 | part | X | X |
| Example 12 | — | | 0.1 | part | 1 | part | X | X |
| Example 13 | — | | 0.25 | part | 1 | part | X | X |
| Example 14 | — | | 0.5 | parts | 1 | part | X | X |
| Example 15 | — | | 0.75 | parts | 1 | part | X | X |
| Example 16 | — | | 1 | part | 1 | part | X | X |
| Example 17 | — | | 1.5 | parts | 1 | part | X | X |
| Example 18 | — | | 2 | parts | 1 | part | X | X |
| Example 19 | — | | 2.5 | parts | 1 | part | X | X |
| Example 20 | — | | 3 | parts | 1 | part | X | X |
| Example 21 | 0.05 | parts | 0.05 | parts | 1 | part | X | X |
| Example 22 | 0.1 | parts | 0.1 | parts | 1 | part | X | X |
| Example 23 | 0.25 | parts | 0.25 | parts | 1 | part | X | X |
| Example 24 | 0.3 | parts | 0.3 | parts | 1 | part | X | X |
| Example 25 | 0.5 | parts | 0.5 | parts | 1 | part | X | X |
| Example 26 | 0.75 | parts | 0.75 | parts | 1 | part | X | X |
| Example 27 | 1 | part | 1 | part | 1 | part | X | X |
| Example 28 | 0.1 | parts | — | | — | | X | X |
| Example 29 | 0.25 | parts | — | | — | | X | X |
| Example 30 | 0.5 | parts | — | | — | | X | X |
| Example 31 | 0.75 | parts | — | | — | | X | X |
| Example 32 | 1 | part | — | | — | | X | X |
| Example 33 | 1.5 | parts | — | | — | | X | X |
| Example 34 | 2 | parts | — | | — | | X | X |
| Example 35 | 2.5 | parts | — | | — | | X | X |
| Example 36 | 3 | parts | — | | — | | X | X |
| Example 37 | — | | 0.1 | part | — | | X | X |
| Example 38 | — | | 0.25 | part | — | | X | X |
| Example 39 | — | | 0.5 | parts | — | | X | X |
| Example 40 | — | | 0.75 | parts | — | | X | X |
| Example 41 | — | | 1 | part | — | | X | X |
| Example 42 | — | | 1.5 | parts | — | | X | X |
| Example 43 | — | | 2 | parts | — | | X | X |
| Example 44 | — | | 2.5 | parts | — | | X | X |
| Example 45 | — | | 3 | parts | — | | X | X |
| Example 46 | 0.05 | parts | 0.05 | parts | — | | X | X |
| Example 47 | 0.1 | parts | 0.1 | parts | — | | X | X |
| Example 48 | 0.25 | parts | 0.25 | parts | — | | X | X |
| Example 49 | 0.3 | parts | 0.3 | parts | — | | X | X |
| Example 50 | 0.5 | parts | 0.5 | parts | — | | X | X |
| Example 51 | 0.75 | parts | 0.75 | parts | — | | X | X |
| Example 52 | 1 | part | 1 | part | — | | X | X |
| Example 53 | 0.1 | parts | — | | 1 | part | — | X |
| Example 54 | 0.25 | parts | — | | 1 | part | — | X |
| Example 55 | 0.5 | parts | | | 1 | part | — | X |
| Example 56 | 0.75 | parts | — | | 1 | part | — | X |
| Example 57 | 1 | part | — | | 1 | part | — | X |
| Example 58 | 1.5 | parts | — | | 1 | part | — | X |
| Example 59 | 2 | parts | — | | 1 | part | — | X |
| Example 60 | 2.5 | parts | — | | 1 | part | — | X |
| Example 61 | 3 | parts | — | | 1 | part | — | X |
| Example 62 | — | | 0.1 | part | 1 | part | — | X |
| Example 63 | — | | 0.25 | part | 1 | part | — | X |
| Example 64 | — | | 0.5 | parts | 1 | part | — | X |
| Example 65 | — | | 0.75 | parts | 1 | part | — | X |
| Example 66 | — | | 1 | part | 1 | part | — | X |
| Example 67 | — | | 1.5 | parts | 1 | part | — | X |
| Example 68 | — | | 2 | parts | 1 | part | — | X |
| Example 69 | — | | 2.5 | parts | 1 | part | — | X |
| Example 70 | — | | 3 | parts | 1 | part | — | X |
| Example 71 | 0.05 | parts | 0.05 | parts | 1 | part | — | X |
| Example 72 | 0.1 | parts | 0.1 | parts | 1 | part | — | X |
| Example 73 | 0.25 | parts | 0.25 | parts | 1 | part | — | X |
| Example 74 | 0.3 | parts | 0.3 | parts | 1 | part | — | X |
| Example 75 | 0.5 | parts | 0.5 | parts | 1 | part | — | X |
| Example 76 | 0.75 | parts | 0.75 | parts | 1 | part | — | X |
| Example 77 | 1 | part | 1 | part | 1 | part | — | X |
| Example 78 | 0.1 | parts | — | | — | | — | X |
| Example 79 | 0.25 | parts | — | | — | | — | X |
| Example 80 | 0.5 | parts | — | | — | | — | X |
| Example 81 | 0.75 | parts | — | | — | | — | X |
| Example 82 | 1 | part | — | | — | | — | X |
| Example 83 | 1.5 | parts | — | | — | | — | X |
| Example 84 | 2 | parts | — | | — | | — | X |
| Example 85 | 2.5 | parts | — | | — | | — | X |
| Example 86 | 3 | parts | — | | — | | — | X |
| Example 87 | — | | 0.1 | part | — | | — | X |
| Example 88 | — | | 0.25 | part | — | | — | X |
| Example 89 | — | | 0.5 | parts | — | | — | X |
| Example 90 | — | | 0.75 | parts | — | | — | X |
| Example 91 | — | | 1 | part | — | | — | X |
| Example 92 | — | | 1.5 | parts | — | | — | X |
| Example 93 | — | | 2 | parts | — | | — | X |
| Example 94 | — | | 2.5 | parts | — | | — | X |
| Example 95 | — | | 3 | parts | — | | — | X |
| Example 96 | 0.05 | parts | 0.05 | parts | — | | — | X |
| Example 97 | 0.1 | parts | 0.1 | parts | — | | — | X |
| Example 98 | 0.25 | parts | 0.25 | parts | — | | — | X |
| Example 99 | 0.3 | parts | 0.3 | parts | — | | — | X |
| Example 100 | 0.5 | parts | 0.5 | parts | — | | — | X |
| Example 101 | 0.75 | parts | 0.75 | parts | — | | — | X |
| Example 102 | 1 | part | 1 | part | — | | — | X |
| Example 103 | 0.1 | parts | — | | 1 | part | X | — |
| Example 104 | 0.25 | parts | — | | 1 | part | X | — |
| Example 105 | 0.5 | parts | | | 1 | part | X | — |
| Example 106 | 0.75 | parts | — | | 1 | part | X | — |
| Example 107 | 1 | part | — | | 1 | part | X | — |
| Example 108 | 1.5 | parts | — | | 1 | part | X | — |
| Example 109 | 2 | parts | — | | 1 | part | X | — |
| Example 110 | 2.5 | parts | — | | 1 | part | X | — |
| Example 111 | 3 | parts | — | | 1 | part | X | — |
| Example 112 | — | | 0.1 | part | 1 | part | X | — |
| Example 113 | — | | 0.25 | part | 1 | part | X | — |
| Example 114 | — | | 0.5 | parts | 1 | part | X | — |
| Example 115 | — | | 0.75 | parts | 1 | part | X | — |
| Example 116 | — | | 1 | part | 1 | part | X | — |
| Example 117 | — | | 1.5 | parts | 1 | part | X | — |
| Example 118 | — | | 2 | parts | 1 | part | X | — |
| Example 119 | — | | 2.5 | parts | 1 | part | X | — |
| Example 120 | — | | 3 | parts | 1 | part | X | — |
| Example 121 | 0.05 | parts | 0.05 | parts | 1 | part | X | — |
| Example 122 | 0.1 | parts | 0.1 | parts | 1 | part | X | — |
| Example 123 | 0.25 | parts | 0.25 | parts | 1 | part | X | — |
| Example 124 | 0.3 | parts | 0.3 | parts | 1 | part | X | — |
| Example 125 | 0.5 | parts | 0.5 | parts | 1 | part | X | — |
| Example 126 | 0.75 | parts | 0.75 | parts | 1 | part | X | — |
| Example 127 | 1 | part | 1 | part | 1 | part | X | — |
| Example 128 | 0.1 | parts | — | | — | | X | — |
| Example 129 | 0.25 | parts | — | | — | | X | — |
| Example 130 | 0.5 | parts | — | | — | | X | — |
| Example 131 | 0.75 | parts | — | | — | | X | — |
| Example 132 | 1 | part | — | | — | | X | — |
| Example 133 | 1.5 | parts | — | | — | | X | — |
| Example 134 | 2 | parts | — | | — | | X | — |
| Example 135 | 2.5 | parts | — | | — | | X | — |
| Example 136 | 3 | parts | — | | — | | X | — |
| Example 137 | — | | 0.1 | part | — | | X | — |
| Example 138 | — | | 0.25 | part | — | | X | — |
| Example 139 | — | | 0.5 | parts | — | | X | — |
| Example 140 | — | | 0.75 | parts | — | | X | — |
| Example 141 | — | | 1 | part | — | | X | — |
| Example 142 | — | | 1.5 | parts | — | | X | — |
| Example 143 | — | | 2 | parts | — | | X | — |
| Example 144 | — | | 2.5 | parts | — | | X | — |
| Example 145 | — | | 3 | parts | — | | X | — |
| Example 146 | 0.05 | parts | 0.05 | parts | — | | X | — |
| Example 147 | 0.1 | parts | 0.1 | parts | — | | X | — |
| Example 148 | 0.25 | parts | 0.25 | parts | — | | X | — |
| Example 149 | 0.3 | parts | 0.3 | parts | — | | X | — |
| Example 1150 | 0.5 | parts | 0.5 | parts | — | | X | — |
| Example 151 | 0.75 | parts | 0.75 | parts | — | | X | — |
| Example 152 | 1 | part | 1 | part | — | | X | — |
| Example 153 | 0.1 | parts | — | | 1 | part | — | — |
| Example 154 | 0.25 | parts | — | | 1 | part | — | — |
| Example 155 | 0.5 | parts | | | 1 | part | — | — |
| Example 156 | 0.75 | parts | — | | 1 | part | — | — |
| Example 157 | 1 | part | — | | 1 | part | — | — |
| Example 158 | 1.5 | parts | — | | 1 | part | — | — |
| Example 159 | 2 | parts | — | | 1 | part | — | — |
| Example 160 | 2.5 | parts | — | | 1 | part | — | — |
| Example 161 | 3 | parts | — | | 1 | part | — | — |
| Example 162 | — | | 0.1 | part | 1 | part | — | — |
| Example 163 | — | | 0.25 | part | 1 | part | — | — |
| Example 164 | — | | 0.5 | parts | 1 | part | — | — |
| Example 165 | — | | 0.75 | parts | 1 | part | — | — |
| Example 166 | — | | 1 | part | 1 | part | — | — |
| Example 167 | — | | 1.5 | parts | 1 | part | — | — |
| Example 168 | — | | 2 | parts | 1 | part | — | — |
| Example 169 | — | | 2.5 | parts | 1 | part | — | — |
| Example 170 | — | | 3 | parts | 1 | part | — | — |
| Example 171 | 0.05 | parts | 0.05 | parts | 1 | part | — | — |
| Example 172 | 0.1 | parts | 0.1 | parts | 1 | part | — | — |
| Example 173 | 0.25 | parts | 0.25 | parts | 1 | part | — | — |
| Example 174 | 0.3 | parts | 0.3 | parts | 1 | part | — | — |
| Example 175 | 0.5 | parts | 0.5 | parts | 1 | part | — | — |
| Example 176 | 0.75 | parts | 0.75 | parts | 1 | part | — | — |
| Example 177 | 1 | part | 1 | part | 1 | part | — | — |

| Example 178 | 0.1 | parts | — | | — | — | — |
|---|---|---|---|---|---|---|---|
| Example 179 | 0.25 | parts | — | | — | — | — |
| Example 180 | 0.5 | parts | — | | — | — | — |
| Example 181 | 0.75 | parts | — | | — | — | — |
| Example 182 | 1 | part | — | | — | — | — |
| Example 183 | 1.5 | parts | — | | — | — | — |
| Example 184 | 2 | parts | — | | — | — | — |
| Example 185 | 2.5 | parts | — | | — | — | — |
| Example 186 | 3 | parts | — | | — | — | — |
| Example 187 | — | | 0.1 | part | — | — | — |
| Example 188 | — | | 0.25 | part | — | — | — |
| Example 189 | — | | 0.5 | parts | — | — | — |
| Example 190 | — | | 0.75 | parts | — | — | — |
| Example 191 | — | | 1 | part | — | — | — |
| Example 192 | — | | 1.5 | parts | — | — | — |
| Example 193 | — | | 2 | parts | — | — | — |
| Example 194 | — | | 2.5 | parts | — | — | — |
| Example 195 | — | | 3 | parts | — | — | — |
| Example 196 | 0.05 | parts | 0.05 | parts | — | — | — |
| Example 197 | 0.1 | parts | 0.1 | parts | — | — | — |
| Example 198 | 0.25 | parts | 0.25 | parts | — | — | — |
| Example 199 | 0.3 | parts | 0.3 | parts | — | — | — |
| Example 200 | 0.5 | parts | 0.5 | parts | — | — | — |
| Example 201 | 0.75 | parts | 0.75 | parts | — | — | — |
| Example 202 | 1 | part | 1 | part | — | — | — |

| Example 203 | 0.1 | part | | X |
|---|---|---|---|---|
| Example 204 | 0.25 | part | | X |
| Example 205 | 0.5 | parts | | X |
| Example 206 | 0.75 | parts | | X |
| Example 207 | 1 | part | | X |
| Example 208 | 1.5 | parts | | X |
| Example 209 | 2 | parts | | X |
| Example 210 | 2.5 | | | X |
| Example 211 | 3.0 | | | X |
| Example 212 | 0.1 | part | X | X |
| Example 213 | 0.25 | part | X | X |
| Example 214 | 0.5 | parts | X | X |
| Example 215 | 0.75 | parts | X | X |
| Example 216 | 1 | part | X | X |
| Example 217 | 1.5 | parts | X | X |
| Example 218 | 2 | parts | X | X |
| Example 219 | 2.5 | | X | — |
| Example 220 | 3.0 | | X | — |
| Example 221 | 0.1 | part | X | — |
| Example 222 | 0.25 | part | X | — |
| Example 223 | 0.5 | parts | X | — |
| Example 224 | 0.75 | parts | X | — |
| Example 225 | 1 | part | X | — |
| Example 226 | 1.5 | parts | X | — |
| Example 227 | 2 | parts | X | — |
| Example 228 | 2.5 | | X | — |
| Example 229 | 3.0 | | X | — |
| Example 230 | 0.1 | part | — | — |
| Example 231 | 0.25 | part | — | — |
| Example 232 | 0.5 | parts | — | — |
| Example 233 | 0.75 | parts | — | — |
| Example 234 | 1 | part | — | — |
| Example 235 | 1.5 | parts | — | — |
| Example 236 | 2 | parts | — | — |

| | | | |
|---|---|---|---|
| Example 237 | 2.5 | — | — |
| Example 238 | 3.0 | — | — |

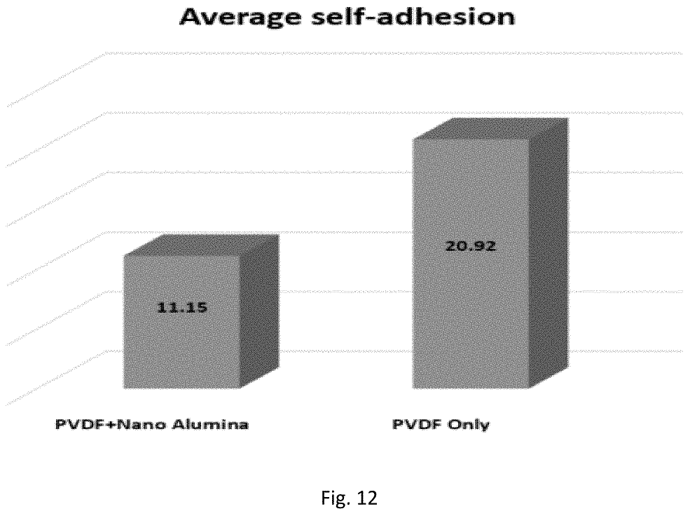

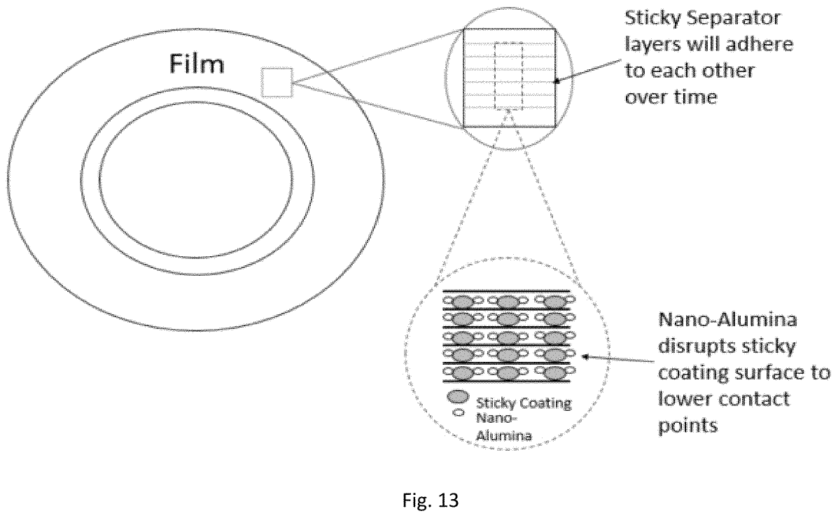

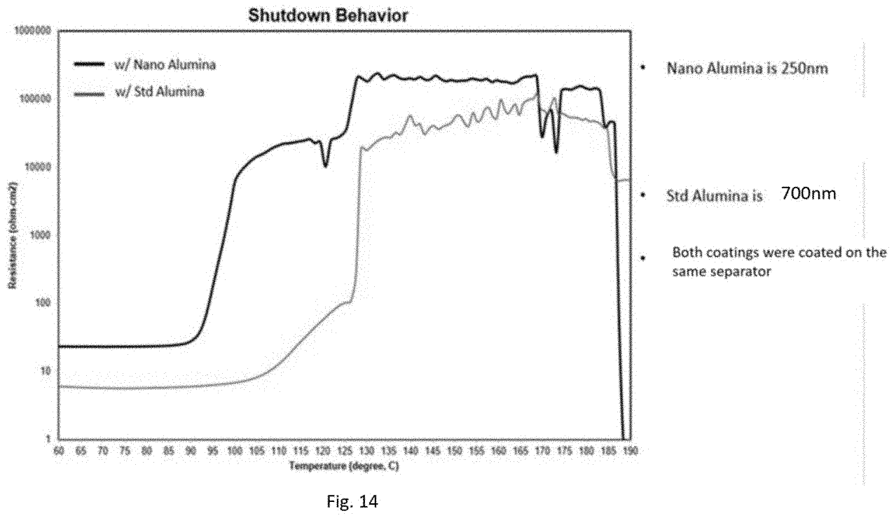

It was found that the use of nano-ceramic or nano-inorganic (nano-alumina in the Examples) resulted in excellent results. For example, use of nano-alumina in a sticky or adhesive coating resulted in about a 50% reduction in self-adhesion as shown in FIG. 12. In FIG. 12, the nano-alumina used had a particle size of 250 nm. Without wishing to be bound by any particular theory, a proposed mechanism explaining why self-adhesion is reduced, is shown in FIG. 13. Nano-ceramic or nano-inorganic (Nano-alumina in the Examples) was also found to improve functioning of a shutdown coating. For example, resistance increased above 100 ohms, above 500 ohms, above 1,000 ohms, above 2,000 ohms, above 3,000 ohms, above 4,000 ohms, above, 5,000 ohms, above 6,000 ohms, above 7,000 ohms, above 8,000 ohms, above 9,000 ohms, or above 10,000 ohms during shutdown. These resistance increases occurred at temperatures less than 135° C., less than, less than 130° C., less than 125° C., less than 120° C., less than 115° C., less than 110° C., less than 105° C., less than 100° C., or less than 95° C. This can be seen in FIG. 14, which compares an embodiment comprising conventional ceramic with a size of 700 nm and an embodiment comprising nano-ceramic with a size of 250 nm. wishing to be bound by any particular theory, it is believed that this improved functioning shutdown coating is due in part to the fact that polymer can flow and block the pores of the separator. With larger sized inorganic or ceramic or heat-resistant particles, it may be more difficult for the polymer to flow and/or block the pores of the separator.

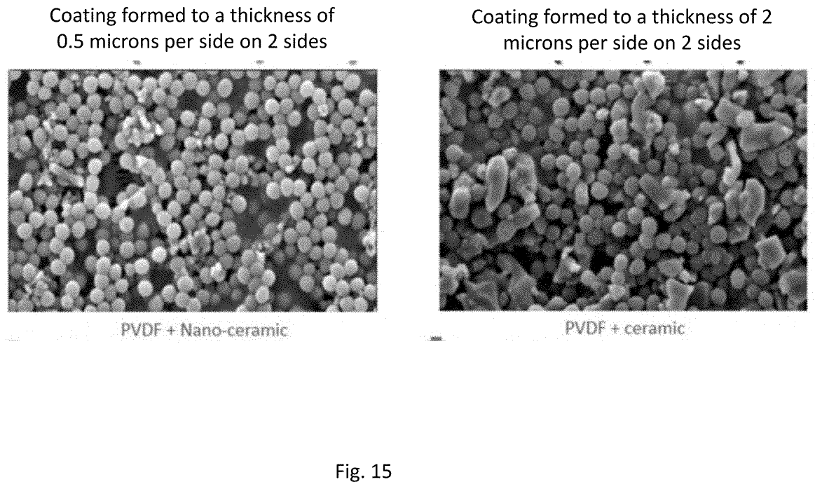

FIG. 15 shows images of coatings containing PVDF and a nano-ceramic and PVDF and a ceramic, respectively. The nano-ceramic containing coating is capable of being made thinner at least in part due to the presence of nano-ceramic.

In some embodiments, aspects or objects, a coated separator comprising a coating on one or two sides of a separator membrane is disclosed. The coating may contain at least one of an adhesion agent, a shutdown agent, and a binder. The coating containing these components does not contain any inorganic or organic heat resistant materials, including ceramic materials, or it contains inorganic or organic heat resistant materials, including ceramic materials, in small amounts. The separator may be a separator that does not, by itself, have shutdown capability. For example, the separator membrane of the separator may be a monolayer separator membrane made of polypropylene. Also disclosed is a battery cell, a secondary battery, and a capacitor containing at least one of the coated separators disclosed herein.

In some embodiments, aspects or objects, a coated separator membrane comprising a coating on one or two sides of a separator membrane is disclosed. The coating may contain at least one of an adhesion agent, a shutdown agent, and a binder. The coating containing these components does not contain any inorganic or organic heat resistant materials, including ceramic materials, or it contains inorganic or organic heat resistant materials, including ceramic materials, in small amounts. The separator may be a separator that does not, by itself, have shutdown capability. For example, the separator membrane of the separator may be a monolayer separator membrane made of polypropylene. Also disclosed is a battery cell, a secondary battery, and a capacitor containing at least one of the coated separators disclosed herein.

In some embodiments, aspects or objects, a coated membrane comprising a coating on one or two sides of a polymer membrane is disclosed. The coating may contain at least one of an adhesion agent, a shutdown agent, and a binder. The coating containing these components may not contain any inorganic or organic heat resistant materials, including ceramic materials, or it contains inorganic or organic heat resistant materials, including ceramic materials, in small amounts. The membrane or base film may be a membrane that does not, by itself, have shutdown capability. For example, the membrane of the coated membrane may be a monolayer or multilayer membrane made of polyolefin, polypropylene, blends, or the like. Also disclosed is a battery, cell, a secondary battery, a capacitor, a textile, a filter, a garment, and/or the like containing at least one of the coated membranes disclosed herein.

In some embodiments, aspects or objects, a multilayer or composite membrane comprising a coating, layer, or treatment on one or two sides of a polymer membrane is disclosed. The coating, layer, or treatment may contain at least one of an adhesion agent, a shutdown agent, and a binder. The coating, layer, or treatment containing these components may not contain any inorganic or organic heat resistant materials, including ceramic materials, or it contains inorganic or organic heat resistant materials, including ceramic materials, in small amounts. The membrane or base film may be a membrane that does not, by itself, have shutdown capability. For example, the base membrane of the multilayer membrane may be a monolayer or multilayer membrane made of polyolefin, polypropylene, blends, or the like. Also disclosed is a battery, cell, a secondary battery, a capacitor, a textile, a filter, a garment, and/or the like containing at least one of the multilayer or composite membranes disclosed herein.

Various embodiments of the present invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention. For example, a non-woven such as a fabric, mesh, net, or the like may be added on one or both sides of the coated separator, of the coated membrane, of the multilayer or composite membrane, and/or the like.

1. A coated separator or a coated porous membrane comprising:
a separator; and
at least one coating that comprises, consists of, or consists essentially of at least one selected from the group of an adhesion agent, a shutdown agent, and a binder, wherein the coating does not contain any of either of inorganic or organic heat resistant particles or contains only a small amount of inorganic and/or organic heat resistant particles (nano or non-nano-particles).

2. The coated separator or coated porous membrane of claim 1, wherein the coating does not contain any of either inorganic or organic heat resistant particles.

3. The coated separator or coated porous membrane of claim 1, wherein the coating contains only a small amount of inorganic and/or organic heat resistant particles.

4. The coated separator or coated porous membrane of claim 1, wherein the coating comprises, consists of, or consists essentially of an adhesion agent, and wherein:
the adhesion agent comprises, consists of, or consists essentially of at least one selected from the group of a wet adhesion agent or a dry adhesion agent;
the adhesion agent comprises, consists of, or consist essentially of a wet adhesion agent;
the adhesion agent comprises, consists of, or consists essentially of a wet adhesion agent that comprises, consists of, or consists essentially of a PVDF, and acrylic polymer, or combinations thereof;
the adhesion agent comprises, consists of, or consists essentially of a dry adhesion agent;
the adhesion agent comprises, consists of, or consists essentially of a dry adhesion polymer that comprises, consists of, or consists essentially of a PVDF-HFP copolymer or an acrylic having a glass transition temperature less than 100° C., preferably between 30° C. and 80° C.;
the adhesion agent comprises, consists of, or consists essentially of a wet adhesion agent and a dry adhesion agent;
the adhesion agent comprises, consists of, or consists essentially of a wet adhesion agent and a dry adhesion agent, wherein the wet adhesion agent comprises, consists of, or consists essentially of a PVDF, an acrylic polymer, or combinations thereof; or
the adhesion agent comprises, consists of, or consists essentially of a wet adhesion agent and a dry adhesion agent, wherein the dry adhesion polymer comprises, consists of, or consists essentially of a PVDF-HFP copolymer or an acrylic having a glass transition temperature less than 100° C., preferably between 30° C. and 80° C.

5. (canceled)

6. (canceled)

7. (canceled)

8. (canceled)

9. (canceled)

10. (canceled)

11. (canceled)

12. (canceled)

13. The coated separator or coated porous membrane of claim 1, wherein the coating comprises, consists of, or consists essentially of a shutdown agent.

14. The coated separator or coated porous membrane of claim 13, wherein:
the shutdown agent comprises, consists of, or consist essentially of beads or particles made of a polymer having a melting point from about 100° C. to about 140° C.;
the shutdown agent comprises, consists of, or consist essentially of beads or particles made of a polymer having a melting point from about 100° C. to about 140° C., and the shutdown agent comprises, consists of, or consists essentially of PE beads; or
the shutdown comprises, consist of, or consists essentially at least one selected from the group of beads or particles made of a polymer having a melting point from about 130° C. to about 140° C.; beads or particles made of a polymer having a melting point from about 80° C. to about 130° C.; beads or particles having a melting point of 140° C. to 220° C., and combinations thereof.

15. (canceled)

16. (canceled)

17. The coated separator or coated porous membrane of claim 1, wherein the coating comprises, consists of, or consists essentially of an adhesion agent and a binder.

18. The coated separator or coated porous membrane of claim 17, wherein the adhesion agent comprises, consists of, or consists essentially of at least one selected from the group of a dry adhesion agent and a wet adhesion agent.

19. The coated separator or coated porous membrane of claim 18, wherein the adhesion agent comprises, consists of, or consists essentially of a dry adhesion agent, and wherein the dry adhesion polymer comprises, consists of, or consists essentially of a PVDF-HFP copolymer or an acrylic having a glass transition temperature less than 100° C., preferably between 30° C. and 80° C.

20. (canceled)

21. The coated separator or coated porous membrane of claim 18, wherein the adhesion agent comprises, consists of, or consists essentially of a wet adhesion agent, and wherein the wet adhesion agent comprises, consists of, or consists essentially of a PVDF, an acrylic polymer, or combinations thereof.

22. (canceled)

23. The coated separator or coated porous membrane of claim 18, wherein the adhesion agent comprises, consists of, or consists essentially of a dry adhesion agent and a wet adhesion agent, wherein:
the wet adhesion agent comprises, consists of, or consists essentially of a PVDF, an acrylic polymer, or combinations thereof; and/or
the dry adhesion polymer comprises, consists of, or consists essentially of a PVDF-HFP copolymer or an acrylic having a glass transition temperature less than 100° C., preferably between 30° C. and 80° C.

24. (canceled)

25. (canceled)

26. The coated separator or coated porous membrane of claim 1, wherein the coating comprises, consists of, or consists essentially of a shutdown agent and a binder.

27. The coated separator or coated porous membrane of claim 26, wherein:
the shutdown agent comprises, consists of, or consist essentially of beads or particles made of a polymer having a melting point from about 100° C. to about 140° C.;
the shutdown agent comprises, consists of, or consist essentially of beads or particles made of a polymer having a melting point from about 100° C. to about 140° C., and the shutdown agent comprises, consists of, or consists essentially of PE beads; or
the shutdown comprises, consist of, or consists essentially at least one selected from the group of beads or particles made of a polymer having a melting point from about 130° C. to about 140° C.; beads or particles made of a polymer having a melting point from about 80° C. to about 130° C.; beads or particles having a melting point of 140° C. to 220° C., and combinations thereof.

28. (canceled)

29. (canceled)

30. The coated separator or coated porous membrane of claim 1, wherein the coating comprises, consists of, or consists essentially of an adhesion agent and a shutdown agent.

31. The coated separator or coated porous membrane of claim 30, wherein the adhesion agent comprises, consists of, or consists essentially of at least one selected from a wet adhesion agent and a dry adhesion agent.

32. The coated separator or coated porous membrane of claim 31, wherein the adhesion agent comprises, consists of, or consists essentially of a wet adhesion agent.

33. The coated separator or coated porous membrane of claim 32, wherein the wet adhesion agent comprises, consists of, or consists essentially of a PVDF, an acrylic polymer, or combinations thereof.

34. The coated separator or coated porous membrane of claim 31, wherein the adhesion agent comprises, consists of, or consists essentially of a dry adhesion agent and a wet adhesion agent.

35. The coated separator or coated porous membrane of claim 34, wherein the wet adhesion agent comprises, consists of, or consists essentially of a PVDF, an acrylic polymer, or combinations thereof, and/or wherein the dry adhesion polymer comprises, consists of, or consists essentially of a PVDF-HFP copolymer or an acrylic having a glass transition temperature less than 100° C., preferably between 30° C. and 80° C.

36. (canceled)

37. The coated separator or coated porous membrane of claim 31, wherein the adhesion agent comprises, consists of, or consists essentially of a dry adhesion agent.

38. The coated separator or coated porous membrane of claim 37, wherein the dry adhesion polymer comprises, consists of, or consists essentially of a PVDF-HFP copolymer or an acrylic having a glass transition temperature less than 100° C., preferably between 30° C. and 80° C.

39. The coated separator or coated porous membrane of claim 30, wherein:
the shutdown agent comprises, consists of, or consist essentially of beads or particles made of a polymer having a melting point from about 100° C. to about 140° C.;
the shutdown agent comprises, consists of, or consist essentially of beads or particles made of a polymer having a melting point from about 100° C. to about 140° C., and the shutdown agent comprises, consists of, or consists essentially of PE beads; or
the shutdown comprises, consist of, or consists essentially at least one selected from the group of beads or particles made of a polymer having a melting point from about 130° C. to about 140° C.; beads or particles made of a polymer having a melting point from about 80° C. to about 130° C.; beads or particles having a melting point of 140° C. to 220° C., and combinations thereof.

40. (canceled)

41. (canceled)

42. The coated separator or coated porous membrane of claim 1, wherein the coating comprises, consists of, or consists essentially of an adhesion agent, a shutdown agent, and a binder.

43. The coated separator or coated porous membrane of claim 42, wherein:
the adhesion agent comprises, consists of, or consists essentially of at least one selected from a wet adhesion agent and a dry adhesion agent;
the adhesion agent comprises, consists of, or consists essentially of a wet adhesion agent;
the adhesion agent comprises, consists of, or consists essentially of a wet adhesion agent, and the wet adhesion agent comprises, consists of, or consists essentially of a PVDF, an acrylic polymer, or combinations thereof;
the adhesion agent comprises, consists of, or consists essentially of a dry adhesion agent and a wet adhesion agent;
the adhesion agent comprises, consists of, or consists essentially of a dry adhesion agent and a wet adhesion agent, wherein the wet adhesion agent comprises, consists of, or consists essentially of a PVDF, an acrylic polymer, or combinations thereof;
the adhesion agent comprises, consists of, or consists essentially of a dry adhesion agent and a wet adhesion agent, wherein the dry adhesion polymer comprises, consists of, or consists essentially of a PVDF-HFP copolymer or an acrylic having a glass transition temperature less than 100° C., preferably between 30° C. and 80° C.;
the adhesion agent comprises, consists of, or consists essentially of a dry adhesion agent; or
the adhesion agent comprises, consists of, or consists essentially of a dry adhesion agent, wherein the dry adhesion polymer comprises, consists of, or consists essentially of a PVDF-HFP copolymer or an acrylic having a glass transition temperature less than 100° C., preferably between 30° C. and 80° C.

44. (canceled)

45. (canceled)

46. (canceled)

47. (canceled)

48. (canceled)

49. (canceled)

50. (canceled)

51. The coated separator or coated porous membrane of claim 42, wherein:
the shutdown agent comprises, consists of, or consist essentially of beads or particles made of a polymer having a melting point from about 100° C. to about 140° C.;
the shutdown agent comprises, consists of, or consist essentially of beads or particles made of a polymer having a melting point from about 100° C. to about 140° C., and the shutdown agent comprises, consists of, or consists essentially of PE beads; or
the shutdown comprises, consist of, or consists essentially at least one selected from the group of beads or particles made of a polymer having a melting point from about 130° C. to about 140° C.; beads or particles made of a polymer having a melting point from about 80° C. to about 130° C.; beads or particles having a melting point of 140° C. to 220° C., and combinations thereof.

52. (canceled)

53. (canceled)

54. (canceled)

55. The coated separator or coated porous membrane of claim 1, wherein the separator is a one-sided or a two-side-coated separator.

56. The coated separator or coated porous membrane of claim 55, wherein the separator is a two-side coated separator and the coatings of the two-side-coated separator are:
the same;
different; or
different, and one of the coatings is a ceramic coating.

57. (canceled)

58. (canceled)

59. The coated separator or coated porous membrane of claim 1, wherein the separator does not have shutdown capability at temperatures below 150° C. or 140° C. without the coating, and wherein the separator that does not have shutdown capability at temperatures below 150° C. or 140° C. without a coating is a dry-process separator.

60. (canceled)

61. The coated separator or coated porous membrane of claim 1, wherein:
the separator is a separator consisting of or consisting essentially of polypropylene;
the separator is a monolayer separator consisting of or consisting essentially of polypropylene; or
the separator is a dry-process monolayer separator consisting of or consisting essentially of polypropylene.

62. (canceled)

63. (canceled)

64. The coated separator or coated porous membrane of claim 1 wherein the coating is a water-based or water-borne coating.

65. The coated separator or coated porous membrane of claim 1 where inorganic or organic heat resistant particles are present, wherein the inorganic or organic heat resistant particles have a particle size from 1 to 1,000 nm, from 250 nm to 1,000 nm, from 1 to 500 nm, or from 1 to 250 nm.

66. (canceled)

67. (canceled)

68. (canceled)

69. (canceled)

70. (canceled)

71. (canceled)

72. (canceled)

73. (canceled)

74. (canceled)

75. A composite comprising the coated separator or coated porous membrane according to claim 1, wherein, an additional coating is provided directly on top of the at least one coating that comprises, consists of, or consists essentially of at least one selected from the group of an adhesion agent, a shutdown agent, and a binder, wherein the coating does not contain any of either of inorganic or organic heat resistant particles or contains only a small amount of inorganic and/or organic heat resistant particles (nano or non-nano-particles).

76. (canceled)

77. (canceled)

78. (canceled)

79. The composite of claim 75, wherein the coating is a water-based or waterborne coating.

80. The composite of claim 75, wherein the coating contains a small amount of inorganic and/or organic heat resistant particles (nano or non-nano-particles) present in an amount less than 10% of the total solid content of the coating, less than 9% of the total solid content of the coating, less than 8% of the total solid content of the coating, less than 7% of the total solid content of the coating, less than 6% of the total solid content of the coating, less than 5% of the total solid content of the coating, less than 4% of the total solid content of the coating, less than 3% of the total solid content of the coating, less than 2% of the total solid content of the coating, or less than 1% of the total solid content of the coating.

81. The composite of claim 75, wherein the additional coating is a ceramic coating, a polymer coating, a coating of electrode material, a coating of solid state electrolyte material, a metal-containing coating, a metallic coating, and/or the like.
